(19) United States
(12) Patent Application Publication
(10) Pub. No.: US 2009/0145919 A1
(43) Pub. Date: Jun. 11, 2009

(54) Vending System

(76) Inventors: Raymond Dueck, Arborg (CA); Ronald Kornelsen, Arborg (CA); Charlie G. Loewen, Arborg (CA)

Correspondence Address: NEUSTEL LAW OFFICES, LTD., 2534 SOUTH UNIVERSITY DRIVE, SUITE 4, FARGO, ND, 58103, US

(21) Appl. No.: 11/950,489

(22) Filed: Dec. 5, 2007

(51) Int. Cl. B65G 59/00

(52) U.S. Cl. 221/119

(57) ABSTRACT

A vending system for efficiently providing a mechanized structure to vend containers. The vending system generally includes an enclosure including at least one door, wherein an inside of the enclosure is accessed via manipulating the door. A conveyor assembly is positioned within the enclosure, wherein the conveyor assembly includes a plurality of compartments to secure a plurality of containers. A drive assembly is mechanically attached between the door and the conveyor assembly, wherein the drive assembly selectively moves the conveyor assembly along a traveling path upon manipulating the at least one door to allow a customer to access a full container within the enclosure.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to vending machines and more specifically it relates to a vending system for efficiently providing a mechanized structure to vend propane tanks.

2. Description of the Related Art

Any discussion of the related art throughout the specification should in no way be considered as all admission that such related art is widely known or forms part of common general knowledge in the field.

Propane is typically a widely utilized source of fuel for various reasons, such as but not limited to the clean burning nature of the propane and the portability of the propane within various size propane tanks (i.e. cylinders). Because of the specific nature in which propane tanks must be filled, the equipment needed to fill the tanks and the highly combustible nature of propane, it is generally required that a professional fill a user's propane tank.

Generally, when a propane tank is empty (i.e. substantially out of propane), a user brings their tank to a particular store and exchanges their empty tank for a full propane tank (i.e. full of propane). A cashier generally assists the user in ensuring that the user exchanges their propane tank for a different tank, wherein the full and empty propane tanks may be kept in various secure locations (e.g. locked cage, etc.). The propane tanks are generally also stored outside the store for various safety reasons.

Exchanging the propane tanks (i.e. empty tank for a full tank) can be a hassle for the business that handles the propane tanks in that the cashier must leave their register to go and exchange the propane tanks. This can also result in customers waiting at the register unassisted or the business needing to constantly ensure that an extra employee is working to exchange propane tanks. Because of the inherent problems with the related art, there is a need for a new and improved vending system for efficiently providing a mechanized structure to vend propane tanks.

### BRIEF SUMMARY OF THE INVENTION

The general purpose of the present invention is to provide a vending system that has many of the advantages of the vending machines mentioned heretofore. The invention generally relates to a vending machine which includes an enclosure including at least one door, wherein an inside of the enclosure is accessed via manipulating the door. A conveyor assembly is positioned within the enclosure, wherein the conveyor assembly includes a plurality of compartments to secure a plurality of containers. A drive assembly is mechanically attached between the door and the conveyor assembly, wherein the drive assembly selectively moves the conveyor assembly along a traveling path upon manipulating the door to allow a customer to access a full container within one of the compartments.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a vending system for efficiently providing a mechanized structure to vend propane tanks.

Another object is to provide a vending system that does not require an external power supply to vend the propane tanks.

An additional object is to provide a vending system that prevents a user from accessing more than one propane tank at a time.

A further object is to provide a vending system that is self-automated.

Another object is to provide a vending system that allows a customer to pay at the vending system thus allowing the present invention to be utilized in areas where a store isn't present and after normal store hours.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front view of the present invention filled with propane tanks.

FIG. 2 is a front view of the present invention filled with propane tanks, wherein the door is opened.

FIG. 3 is a front view of the present invention filled with propane tanks, wherein the door and the panel are opened.

FIG. 4 is an upper perspective view of the drive assembly attached to a portion of the conveyor assembly.

FIG. 5 is a top view of the present invention, wherein both the door and the panel are in a closed position.

FIG. 6 is a cross-sectional view of the connection between the drive assembly and the drive sprocket of the conveyor assembly during the process illustrated in FIG. 5.

FIG. 7 is a top view of the present invention, wherein the door is partially open and the panel is closed.

FIG. 8 is a cross-sectional view of the connection between the drive assembly and the drive sprocket of the conveyor assembly during the process illustrated in FIG. 7.

FIG. 9 is a top view of the present invention, wherein the door is fully opened and the panel is closed.

FIG. 10 is a cross-sectional view of the connection between the drive assembly and the drive sprocket of the conveyor assembly during the process illustrated in FIG. 9.

FIG. 11 is a top view of the present invention, wherein the door is fully opened and the panel partially opened.

FIG. 12 is a top view of the present invention, wherein the door and the panel are fully opened.

FIG. 13 is a cross-sectional view of the connection between the drive assembly and the drive sprocket of the conveyor assembly during the process illustrated in FIG. 12.

FIG. 14 is a top view of the present invention, wherein the door and the panel are fully opened and the ratcheting sprocket is being manipulated via the lever.

FIG. 15 is a top view of the present invention, wherein the door and the panel are fully opened and the ratcheting sprocket is being further manipulated via the lever.

FIG. 16 is a cross-sectional view of the connection between the drive assembly and the drive sprocket of the conveyor assembly during the process illustrated in FIG. 15.

FIG. 17 is a top view of an alternative embodiment of the present invention including an actuator.

### DETAILED DESCRIPTION OF THE INVENTION

### A. Overview

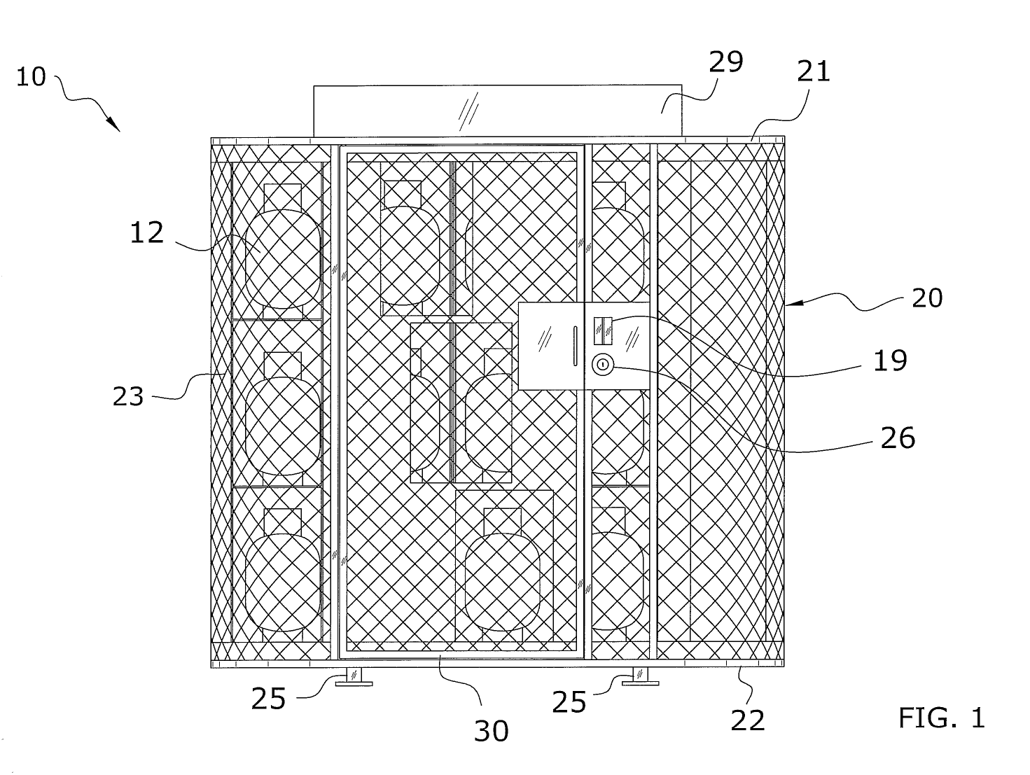

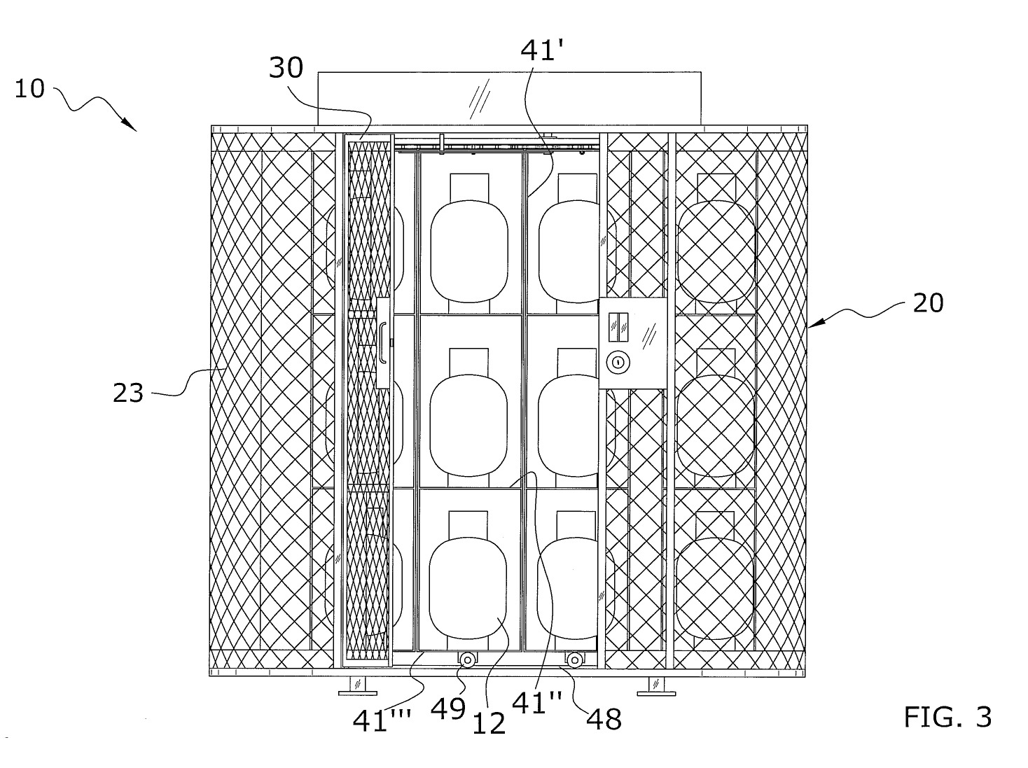

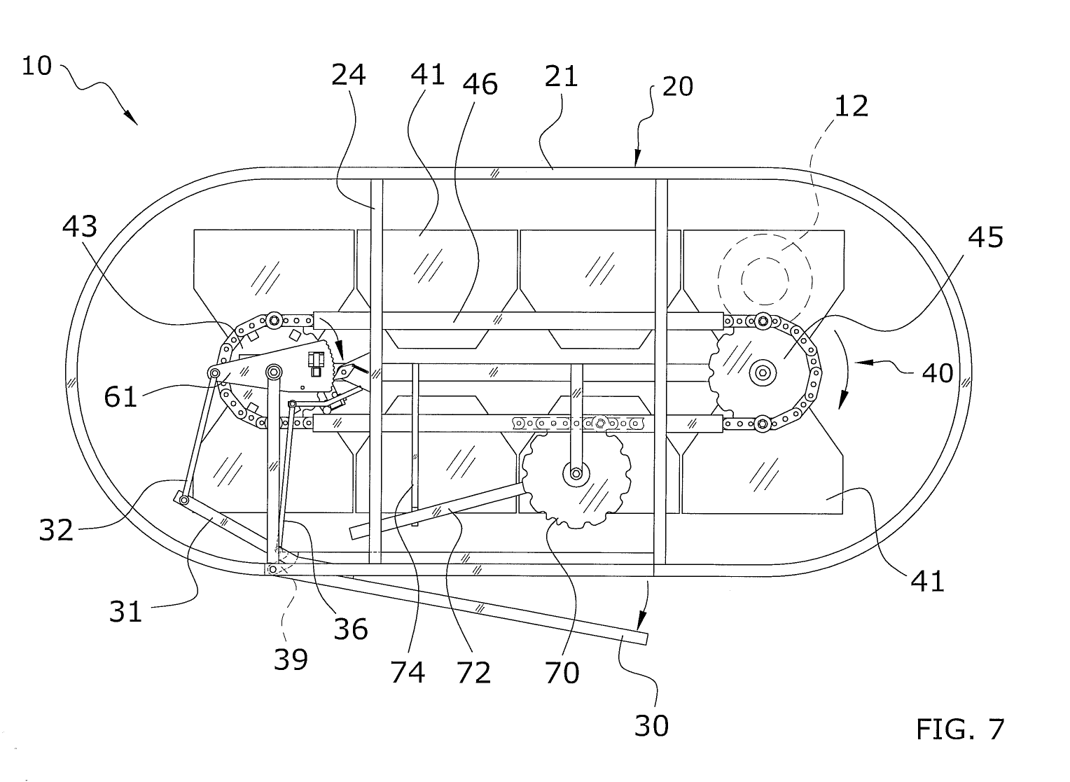

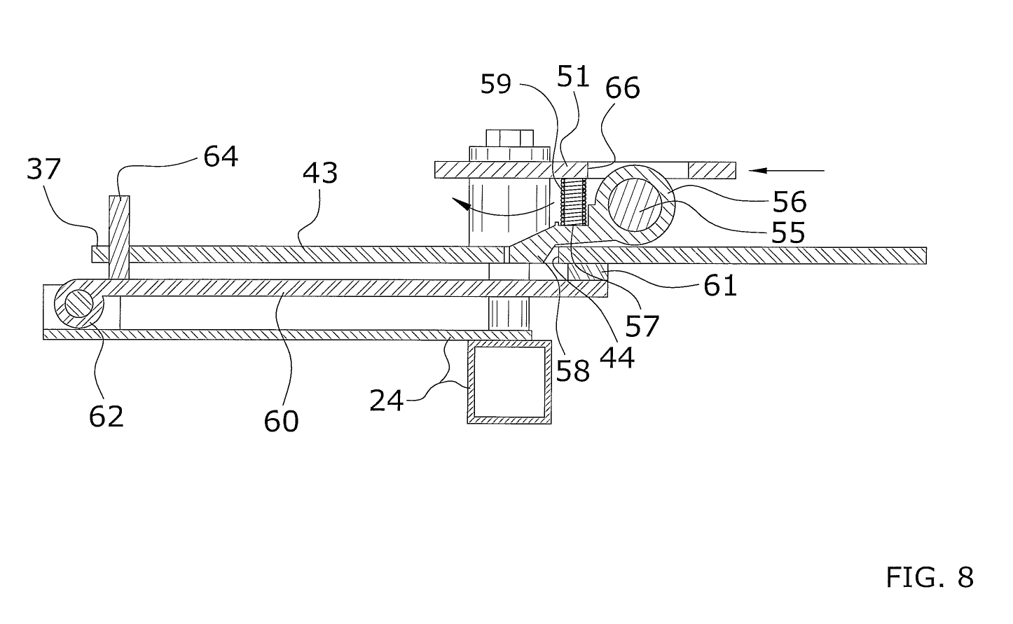

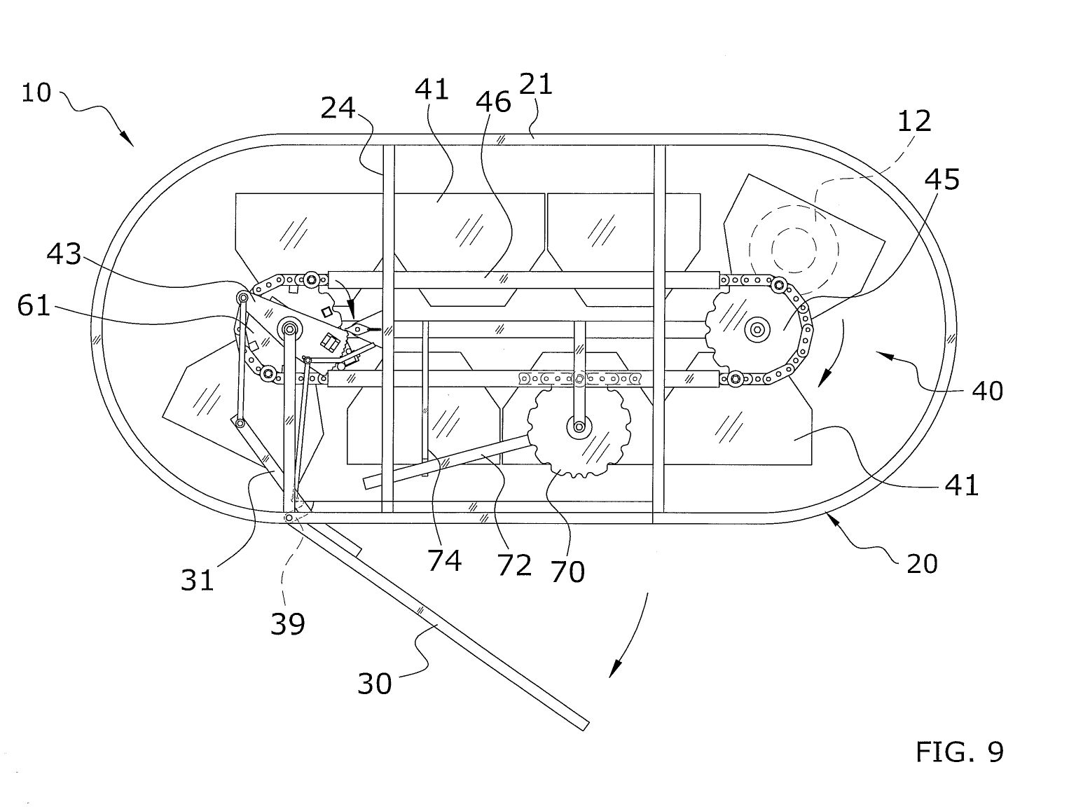

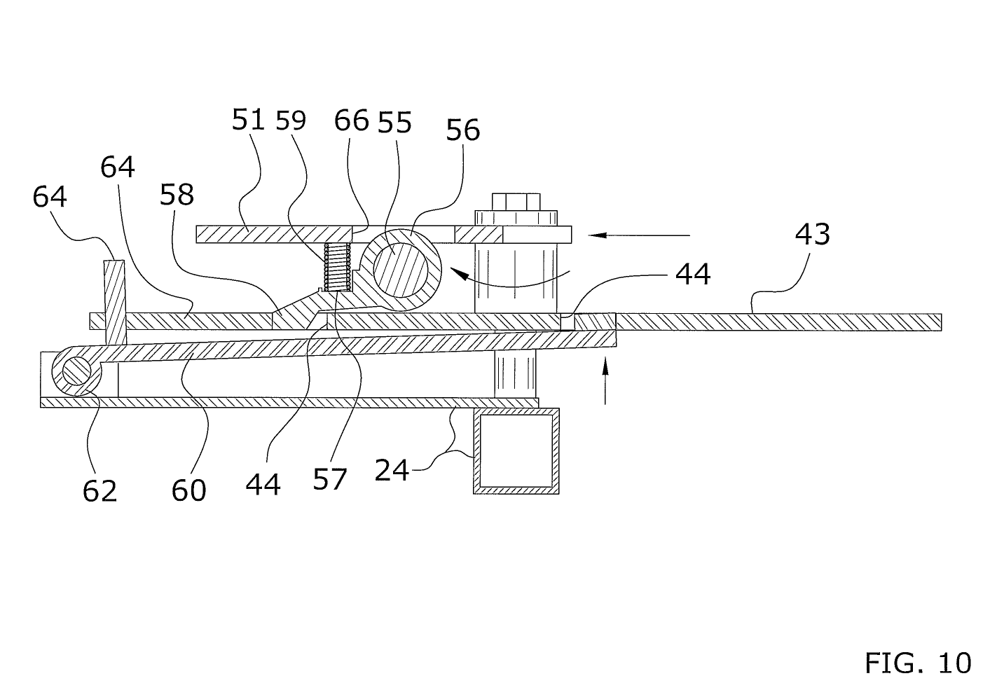

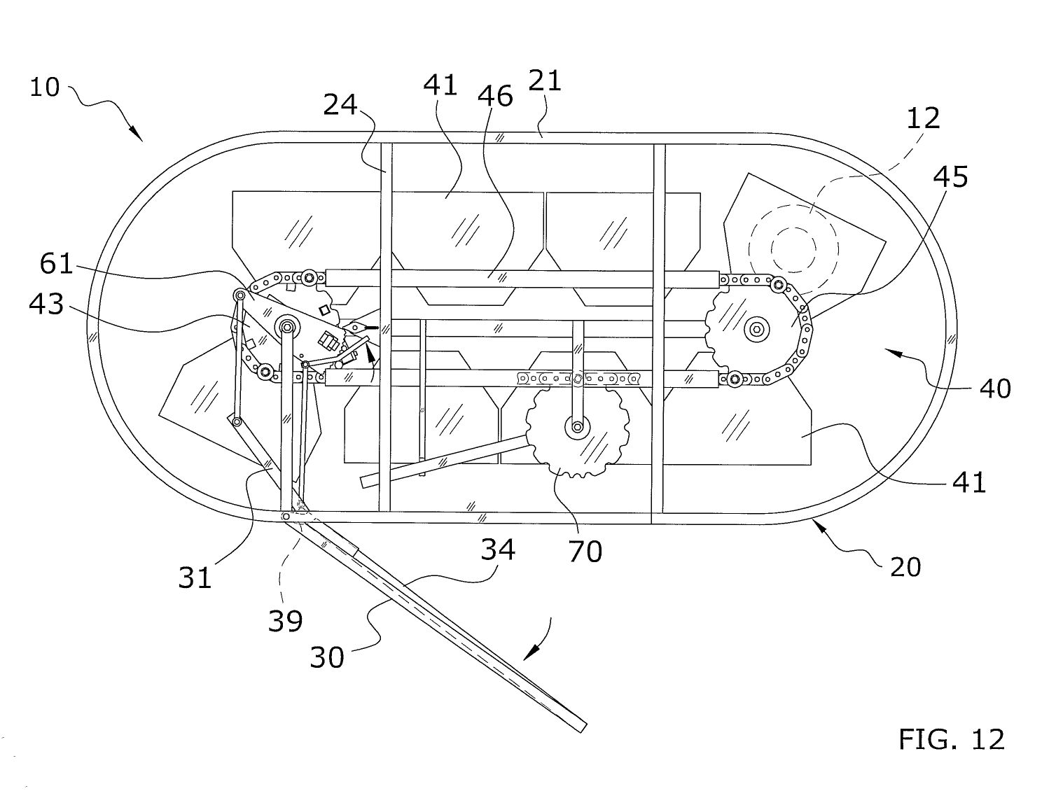

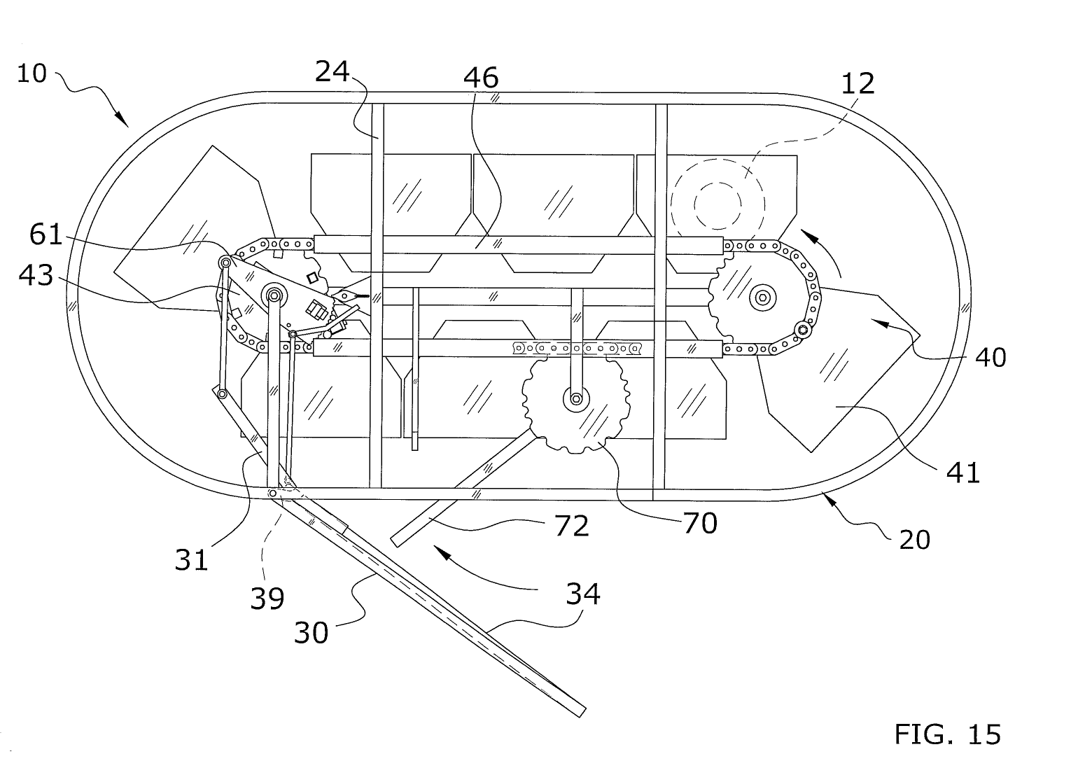

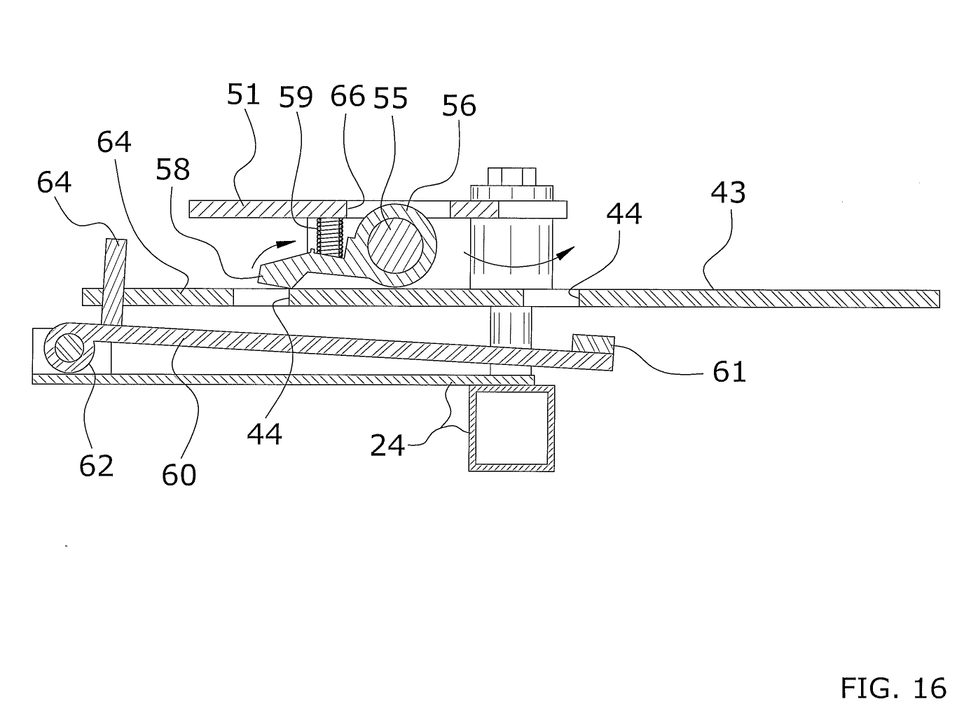

Turning now descriptively to the drawings, in which similar reference characters denote similar elements throughout the several views, FIGS. 1 through 17 illustrate a vending system 10, which comprises an enclosure 20 including at least one door 30, wherein an inside of the enclosure 20 is accessed via manipulating the door 30. A conveyor assembly 40 is positioned within the enclosure 20, wherein the conveyor assembly 40 includes a plurality of compartments 41′, 41″, 41′″ to secure a plurality of containers 12 (e.g. propane tanks, etc.). A drive assembly 50 is mechanically attached between the door 30 and the conveyor assembly 40, wherein the drive assembly 50 selectively moves the conveyor assembly 40 along a traveling path upon manipulating the door 30 to allow a customer to access a full container 12 within one of the compartments 41′, 41″, 41′″.

### B. Enclosure

The enclosure 20 secures a plurality of containers 12 within and is also configured to prevent an individual from removing any of the enclosed containers 12 without operating the present invention in a standard manner (i.e. inserting a form of payment and opening the door 30). It is appreciated that the form of payment may be received at the enclosure 20, by a cashier within a respective store, wherein the cashier manually or remotely unlocks the door 30 to allow access to the containers 12 within the enclosure 20, or various other manners. The enclosure 20 may be comprised of various materials all of which are capable of supporting the present invention, withstanding various weather climates and attempted break-ins.

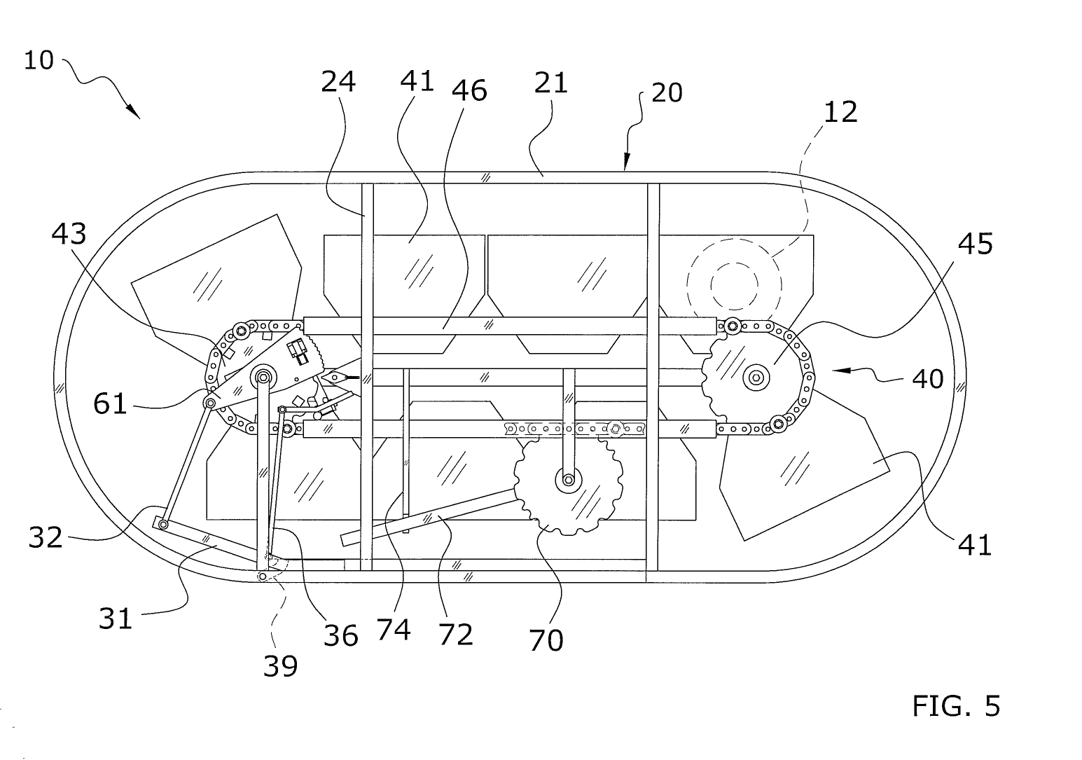

In the preferred embodiment, the enclosure 20 is comprised of a hollow ovular structure to match the traveling path and shape of the conveyor assembly 40 as illustrated in FIG. 5; however it is appreciated that the enclosure 20 may be comprised of various configurations. The enclosure 20 may also include various portions (i.e. separate structures), such as a consumer portion (portion of the enclosure 20 that the consumer utilizes) and a storage portion (portion of the enclosure 20 that stores the containers 12).

The enclosure 20 may also include various supports 24 to connect to and support various components (i.e. conveyor assembly 40, drive assembly 50, etc.) of the present invention, wherein the supports 24 may be comprised of various configurations (e.g. plates, tubular members, etc.). The enclosure 20 may further include a plurality of legs 25 to support the enclosure 20 above the ground surface as illustrated in FIGS. 1 through 3.

In the preferred embodiment of the present invention, a distance from the lower end 22 to the upper end 21 of the enclosure 20 is preferably substantially similar or slightly greater than the height of 3 containers 12 stacked upon one another, wherein the enclosure 20 preferably encompasses at least 3 rows of containers 12. However, it is appreciated that the enclosure 20 may be comprised of various heights and sizes to accommodate various size and/or amounts of containers 12.

In the preferred embodiment, the present invention preferably vends 20 pound containers 12; however it is appreciated that the present invention may be scaled or configured to dispense various size containers 12 rather than the preferred embodiment. It is also appreciated that the present invention may vend various other items rather than containers 12. It is further appreciated that the enclosure 20 may include an advertising space 29 for various purposes, such as to label the purpose of the present invention or display various indicia.

The enclosure 20 is preferably surrounded by a cage 23 to allow an individual to view within the enclosure 20 as illustrated in FIGS. 1 through 3. It is appreciated however that the enclosure 20 may be surrounded by various other structures and/or materials rather than a cage 23, such as but not limited to a Plexiglas material.

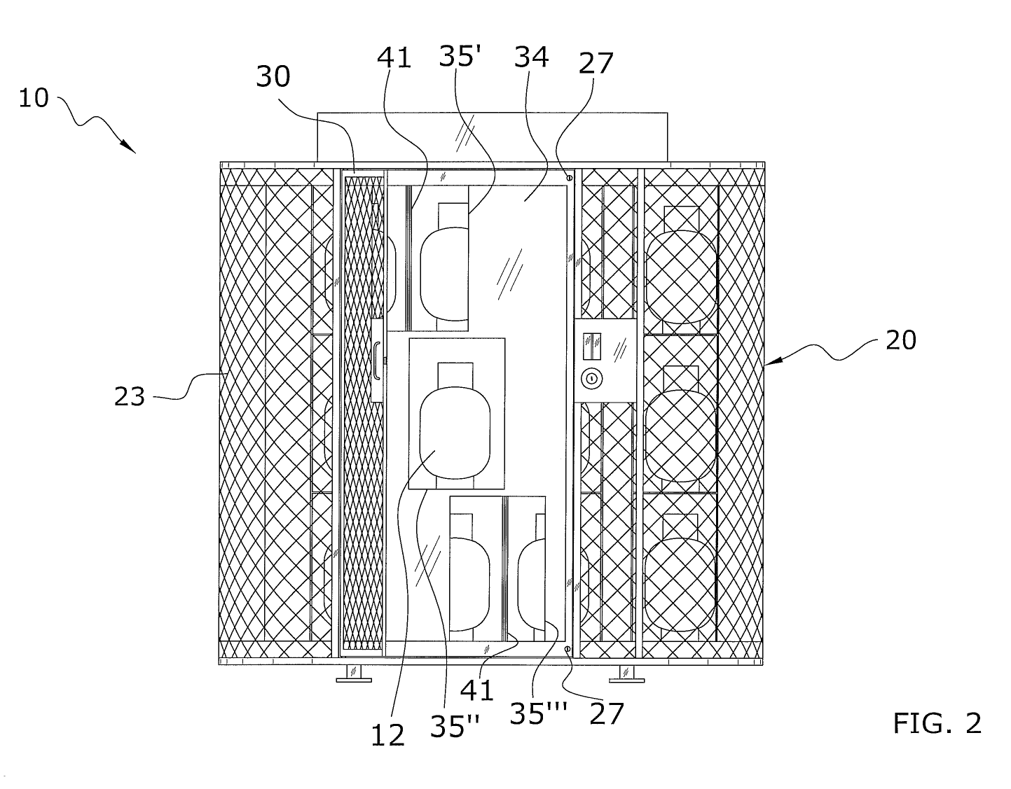

The enclosure 20 also includes a door 30 and a panel 34, wherein the door 30 and the panel 34 are both preferably pivotally attached to a pivoting member 39 near the upper end 21 of the enclosure 20 as illustrated in FIGS. 5, 7, 9, 11 and 12. The door 30 is utilized by the customer to access a single container 12 within the enclosure 20 and also to replace their empty container 12 within the enclosure 20. It is appreciated that when the door 30 is opened, the customer views the panel 34 and a select number of containers 12 through the dispenser openings 35′, 35″, 35′″ of the panel 34 and a door opening through the enclosure formed by opening the door 30 as illustrated in FIG. 2.

Extending from the door 30 is preferably an extension member 31. The extension member 31 preferably angles slightly inward and subsequently pivotally connects to a first connecting member 32. The first connecting member 32 in turn pivotally connects to a ratcheting member 51 of the drive assembly 50.

When the door 30 is being opened, the extension member 31 and the first connecting member 32 work together to manipulate (i.e. by pushing) the ratcheting member 51. The ratcheting member 51 is thus forced to rotate the drive sprocket 43 and conveyor assembly 40. When the door 30 is being closed, the extension member 31 and the first connecting member 32 manipulate the ratcheting member 51 in an opposing direction to reset the ratcheting member 51 for future operation.

The door 30 is selectively locked by a first lock 26. The first lock 26 preferably includes a payment device 19, wherein a user may selectively unlock the first lock 26 to allow the door 30 to open by inserting the proper payment within the payment device 19. The payment device 19 may also be separate than the enclosure 20, wherein the payment device 19 may be located within a store and managed by a cashier. It is appreciated that the payment device 19 may accept various forms of payment, such as but not limited to credit cards, debit cards or cash.

The panel 34 remains locked when the customer is utilizing the present invention. The panel 34 prevents the customer from accessing more than one container 12 within the enclosure 20. The panel 34 may also open in a manner consistent with the door for maintenance personnel. The panel 34 is generally only opened by the maintenance personnel (e.g. individual replacing the empty containers 12 within the enclosure 20 with full containers 12, individual fixing a component of the present invention, etc.).

When the panel 34 is opened, the maintenance personnel has access to a plurality of containers 12 to allow the maintenance personnel to more quickly interchange empty containers 12 with full containers 12. The door 30 and the panel 34 also each preferably include a handle to allow the user to easily open the doors 30, 34. The panel 34 includes a plurality of dispenser openings 35′, 35″, 35′″ extending through the panel 34 as illustrated in FIG. 2. The dispenser openings 35′, 35″, 35′″ are preferably staggered; however it is appreciated that the compartments 41′, 41″, 41′″ may be staggered rather than the dispenser openings 35′, 35″, 35′″.

The dispenser openings 35′, 35″, 35′″ are staggered in such a manner as to allow a customer to access only one container 12 at a time, wherein only one dispenser opening 35′, 35″, 35′″ properly aligns with a respective container 12 and compartment 41′, 41″, 41′″ each time the door 30 is opened (as illustrated in FIG. 2 with the dispenser opening 35″ aligning with the compartment 41″). The dispenser openings 35′, 35″, 35′″ of the panel 34 are also configured so the “next” container 12 that is available is vertically above or below the “previously” accessed container 12 with respect to the plurality of rows of the conveyor assembly 40 and containers 12. The openings 35′, 35″, 35′″ are further preferably vertically staggered.

Extending from the panel 34 is preferably a second connecting member 36 that is pivotally connected to the panel 34 via the pivoting member 39. The second connecting member 36 extends toward the conveyor assembly 40 and the drive assembly 50. The second connecting member 36 in turn pivotally connects to an engaging member 37. The engaging member 37 is comprised of a slightly “L” shaped configuration and when pivoted engages the restrictor member 60.

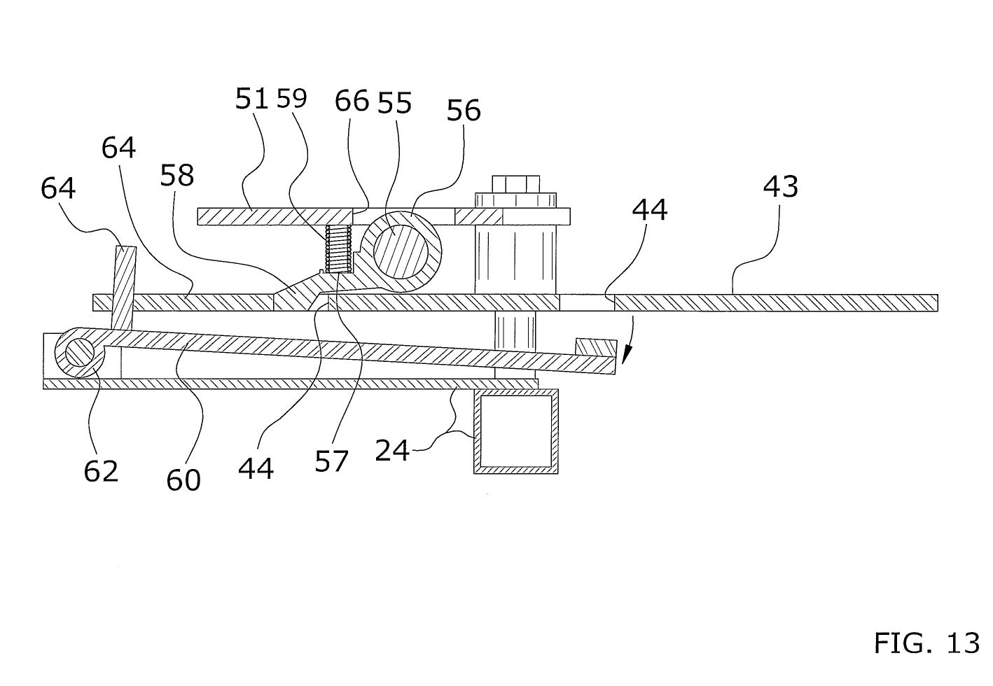

When the panel 34 is opened, the second connecting member 36 is pulled towards the panel 34 and the engaging member 37 is also pulled towards the panel 34. Pulling the engaging member 37 causes the opposing end of the engaging member 37 to pivot away from the door and thus engage the restrictor member 60. The restrictor member 60 thus pivots away from the drive sprocket 43 and allows the drive sprocket 43 and conveyor assembly 40 to freely rotate as illustrated in FIG. 13. When the panel 34 is closed, the engaging member 37 pivots away from the restrictor member 60 thus allowing the restrictor member 60 to lock itself within the radial opening 44 of the drive sprocket 43, thus preventing the drive sprocket 43 and conveyor assembly 40 from freely rotating.

The panel 34 is selectively locked via a second lock 27. The second lock 27 preferably opens via a lock or combination, is separate than the first lock 26 and is not operable via the payment device 19 to prevent the customer from opening the panel 34.

### C. Conveyor Assembly

The conveyor assembly 40 is positioned within the enclosure 20 as illustrated in FIG. 5. The conveyor assembly 40 rotates along a traveling path a certain amount each time the door 30 is opened. It is appreciated however that the conveyor assembly 40 may transfer the containers 12 in other manners rather than rotating. It is appreciated that the conveyor assembly 40 may or may not be attached to the enclosure 20 via various supports 24.

The conveyor assembly 40 includes a plurality of compartments 41′, 41″, 41′″ to each individual secure a respective container 12, wherein the compartments 41′, 41″, 41′″ are also preferably separably formed. It is appreciated that individual rows of compartments 41′, 41″, 41′″ of the present invention may be integrally formed; however the individual columns of each row are preferably separably formed to allow the compartments 41′, 41″, 41′″ to efficiently move along the traveling path of the conveyor assembly 40. The conveyor assembly 40 preferably includes a plurality of rows, wherein the rows are stacked horizontally.

The conveyor assembly 40 is preferably rotated via a chain and sprocket assembly (i.e. chain 42, drive sprocket 43, idler sprockets 45) as illustrated in FIG. 5. In the preferred embodiment there is preferably a chain and sprocket assembly positioned adjacent the upper end 21 and the lower end 22 of the enclosure 20, wherein the compartments 41′, 41″, 41′″ are attached between the upper and lower chain and sprocket assemblies. The upper and lower chain and sprocket assemblies are also preferably interconnected (via a shaft extending between the upper and lower end 22 or other manners), wherein the present invention may only include a total of one drive sprocket 43 and a plurality of idler sprockets 45 to rotate the conveyor assembly 40.

The chain and sprocket assembly may also include a plurality of stabilizer members 47 equidistantly spaced along the upper and lower chains 42. The stabilizer members 47 prevent the chain 42 from swaying from side to side by extending within a guide member 46. The guide members 46 are preferably comprised of an elongated U-shaped structure comprised of a similar width as the stabilizer members 47. To further stabilize the conveyor assembly 40, the present invention may include a track 48 and roller 49 assembly to support the lower end of the conveyor assembly 40.

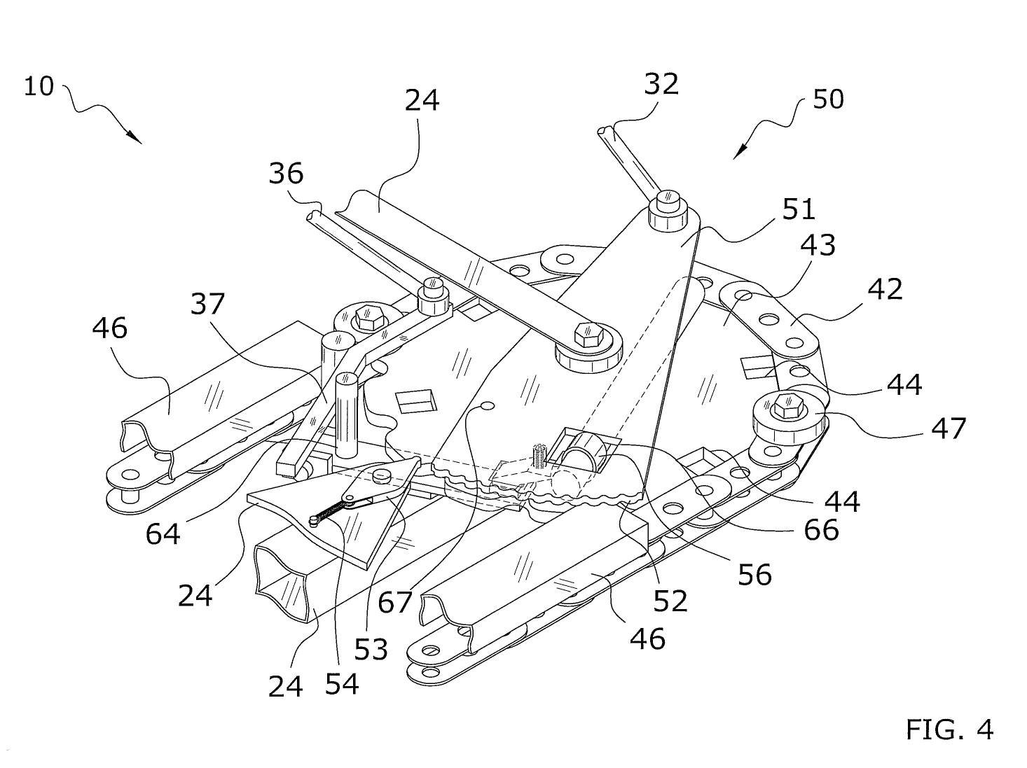

At least one of the sprockets 43, 45 of the chain and sprocket assembly functions as a drive sprocket 43. The drive sprocket 43 is preferably positioned adjacent the upper end 21 of the enclosure 20 and the pivoting point of the doors. The drive sprocket 43 includes a plurality of radial openings 44 to selectively catch a portion of the drive assembly 50 and subsequently prevent the conveyor assembly 40 from rotating beyond a predetermined point as illustrated in FIG. 4.

The radial openings 44 are preferably equidistantly spaced around the drive sprocket 43. In the preferred embodiment, the radial openings 44 are comprised of rectangular shaped configuration to efficiently receive the securing member 56 and the restrictor member 60; however it is appreciated that the radial openings 44 may be comprised of various configuration openings rather than the preferred embodiment.

### D. Drive Assembly

The drive assembly 50 is positioned adjacent the drive sprocket 43 as illustrated in FIGS. 4 and 5. The drive assembly 50 selectively manipulates the drive sprocket 43 to rotate the drive sprocket 43 and also to stop the drive sprocket 43 from rotating thus activating and deactivating the conveyor assembly 40. The drive assembly 50 includes a ratcheting member 51 extending from the first connecting member 32 and rotatably attached to a shaft extending through the drive sprocket 43. The ratcheting member 51 includes a plurality of teeth 52 extending along an arced portion of the ratcheting member 51. The teeth 52 are also positioned upon the ratcheting member 51 upon an opposite side as the first connecting member 32.

The teeth 52 of the ratcheting member 51 selectively engage a pawl 53 pivotally attached to a support 24 of the present invention (the support 24 may extend from various components of the present invention including the enclosure 20, the conveyor assembly 40 or the drive assembly 50). The ratcheting member 51 is attached to the shaft in a ratcheting member 51 thus allowing the ratcheting member 51.

A first spring 54 (e.g. tension spring, etc.) is also attached between the pawl 53 and the support 24. The first spring 54 allows the pawl 53 to return to an originally oriented position after being engaged by the ratcheting member 51. A securing member 56 and a spacer member 55 are also attached between the ratcheting member 51 and the drive sprocket 43 as illustrated in FIG. 4. The spacer member 55 is preferably fixedly attached to the lower side of the ratcheting member 51 and the securing member 56 is rotatably attached to the spacer member 55. The ratcheting member 51 may also include a first opening 66, wherein the securing member 56 extends through the first opening 66.

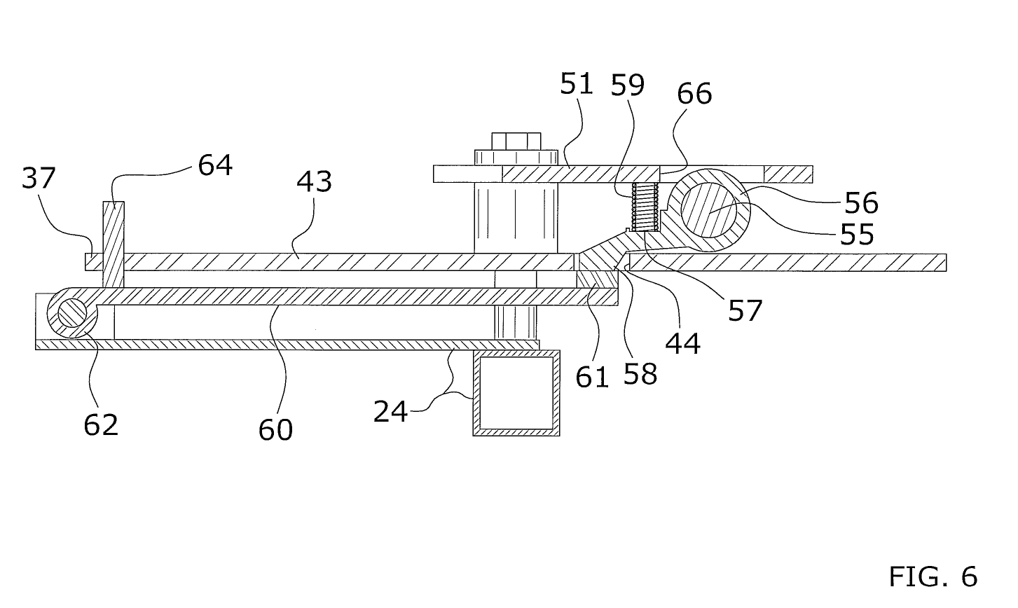

The securing member 56 selectively engages and secures itself within the radial openings 44 of the drive sprocket 43 thus selectively preventing the conveyor assembly 40 from moving along the traveling path as illustrated in FIGS. 4 and 6. A second spring 59 is preferably positioned between a retaining portion 57 of the securing member 56 and the lower side of the ratcheting member 51 to maintain an outward force upon the securing member 56 away from the ratcheting member 51.

A securing portion 58 of the securing member 56 extends from the retaining portion 57 and selectively extends within a respective radial opening 44 of the drive sprocket 43. The securing portion 58 is configured to maintain a position within the radial opening 44 when door 30 is opened and to be released from the respective radial opening 44 when closing the door 30 so the securing portion 58 may enter within an adjacent radial opening 44.

The drive assembly 50 also includes the restrictor member 60 extending from a support 24 of the present invention (the support 24 may extend from various components of the present invention including the enclosure 20, the conveyor assembly 40 or the drive assembly 50). The restrictor member 60 and connecting parts comprise a locking structure of the drive assembly 50. The restrictor member 60 is also pivotally attached to the support 24. The restrictor member 60 is preferably comprised of an “L” shaped configuration to selectively extend from the support 24 and within a radial opening 44 of the drive sprocket 43.

The restrictor member 60 includes a transverse portion 64 perpendicularly extending from the restrictor member 60 adjacent a pivoting end 62 of the restrictor member 60. The transverse portion 64 is selectively engaged by the engaging member 37 when opening the panel 34 thus causing the pivoting end 62 of the restrictor member 60 to pivot away from the drive sprocket 43. The opposing end of the restrictor member 60 (i.e. locking end 61) is thus pivoted away from the radial opening 44 to allow the maintenance personnel to freely rotate the drive sprocket 43 and the conveyor assembly 40.

When the door 30 is opened the locking end 61 of the restrictor member 60 positions itself within a radial opening 44 adjacent the radial opening 44 that the securing member 46 is positioned within. This prevents the customer from physically rotating the conveyor assembly 40. When the door 30 is closed the securing portion 48 of the securing member 56 moves toward the radial opening 44 (that the locking end 61 of the restrictor member 60 is positioned within) and subsequently pushes the locking end 61 out of the radial opening 44. This process repeats itself every time the door 30 is opened and closed.

The drive assembly 50 also preferably includes a ratcheting sprocket 70 positioned adjacent the panel 34. The ratcheting sprocket 70 is sealed behind the panel 34 and is only accessible once the panel 34 is opened. Manipulating the ratcheting sprocket 70 in turn rotates the conveyor assembly 40 along an opposing direction as the traveling path. Rotating the conveyor assembly 40 along the opposing path allows the securing member 56 to skip in and out of the radial openings 44 and allows the maintenance personnel to maneuver the conveyor assembly 40 a full rotation (all the way around).

The ratcheting sprocket 70 interconnects with the chain 42 and freely rotates during normal operation of the present invention (i.e. customer utilizing the present invention). A lever 72 extends from the ratcheting sprocket 70 to allow the maintenance personnel to rotate the ratcheting sprocket 70 in the opposing direction as during the normal operation of the present invention. The lever 72 and ratcheting sprocket 70 thus function in a ratcheting manner. The present invention may also include a rest 74 extending from one of the supports 24 to secure the lever 72 when not in use.

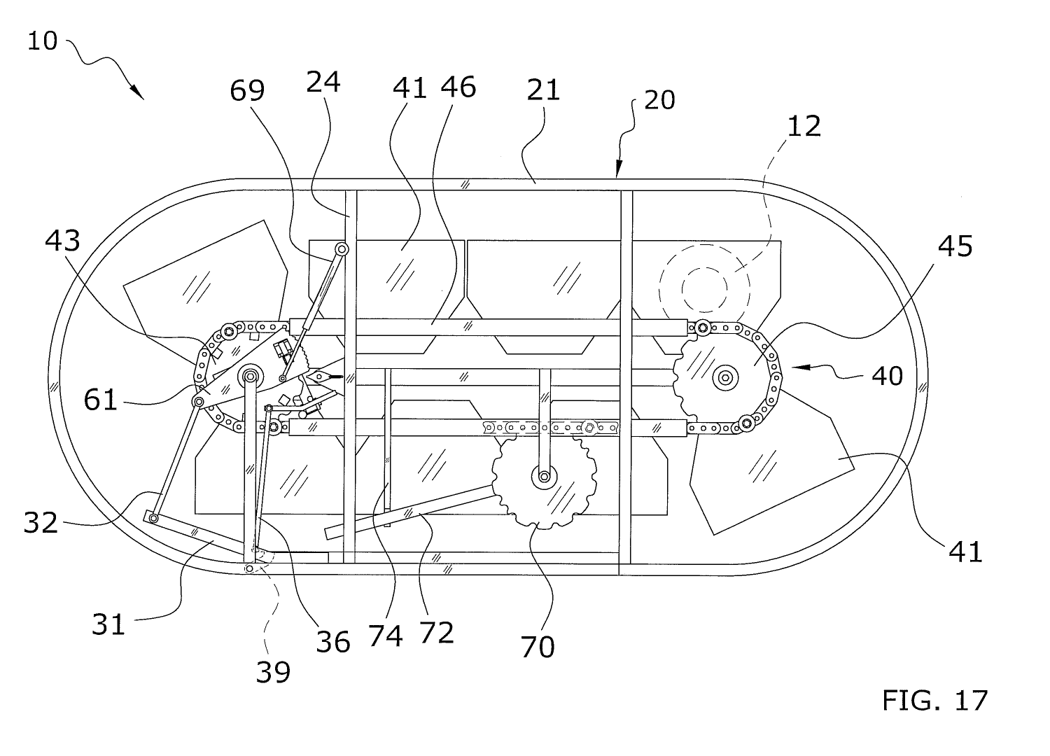

In an alternative embodiment of the present invention, the drive assembly 50 may include an actuator 69 mechanically connected between a support 24 and an aperture 67 of the ratcheting member 51 as illustrated in FIG. 17. The actuator 69 is comprised of a hydraulic or pneumatic cylinder and serves to assist the customer in manipulating the ratcheting member 51 by pushing or pulling on the ratcheting member 51 in a manner similar to previously done when the customer opens and closes the door 30.

### E. Operation of Preferred Embodiment

In use, the customer first enters in an appropriate amount of payment within the payment device 19 (i.e. cost for exchanging an empty container 12 with a full container 12), wherein the payment device 19 may be located upon the enclosure 20, within a respective store or various other locations. Once the payment device 19 receives the correct amount of payment, the first lock 26 is released (i.e. released automatically, unlocked by a cashier, etc.) and the customer is able to open the door 30. When the door 30 is opened, the extension member 31 is pivoted toward the drive assembly 50 thus causing the first connecting member 32 to also move towards the drive assembly 50.

The first connecting member 32 in turn pushes on the ratcheting member 51 and the securing member 56 (positioned within radial opening 44) of the ratcheting member 51 rotates the driving sprocket which in turn rotates the conveyor assembly 40. It is appreciated that the door 30 must be fully opened to release the pawl 53 from the teeth 52 of the ratcheting member 51 and allow the pawl 53 to be reset. The opening of the door 30 is also illustrated in FIGS. 5 through 10.

Once the door is fully opened, the customer may retrieve the accessible container 12 from a respective compartment 41′, 41″, 41′″ and replace their empty container 12 within the respective compartment 41′, 41″, 41′″. The customer may now close the door 30. As the door 30 is closed the previously described components move in an opposing manner as previously described.

The securing member 56 is thus forced out of the radial opening 44 that it was previously positioned within and moves along a radial path of the drive sprocket 43 towards and within the next radial opening 44. The door 30 also preferably locks automatically when the door 30 is closed via the first lock 26. The ratcheting member 51 is now reset for future operation of the present invention.

When the present invention requires refilling (i.e. exchanging empty containers 12 for full containers 12), the door 30 and the panel 34 are both opened via the first lock 26 and the second lock 27. When opening the panel 34, the second connecting member 36 and the engaging member 37 work together to push on the transverse portion 64 of the restrictor member 60, thus causing the restrictor member 60 to be released from the respective radial opening 44.

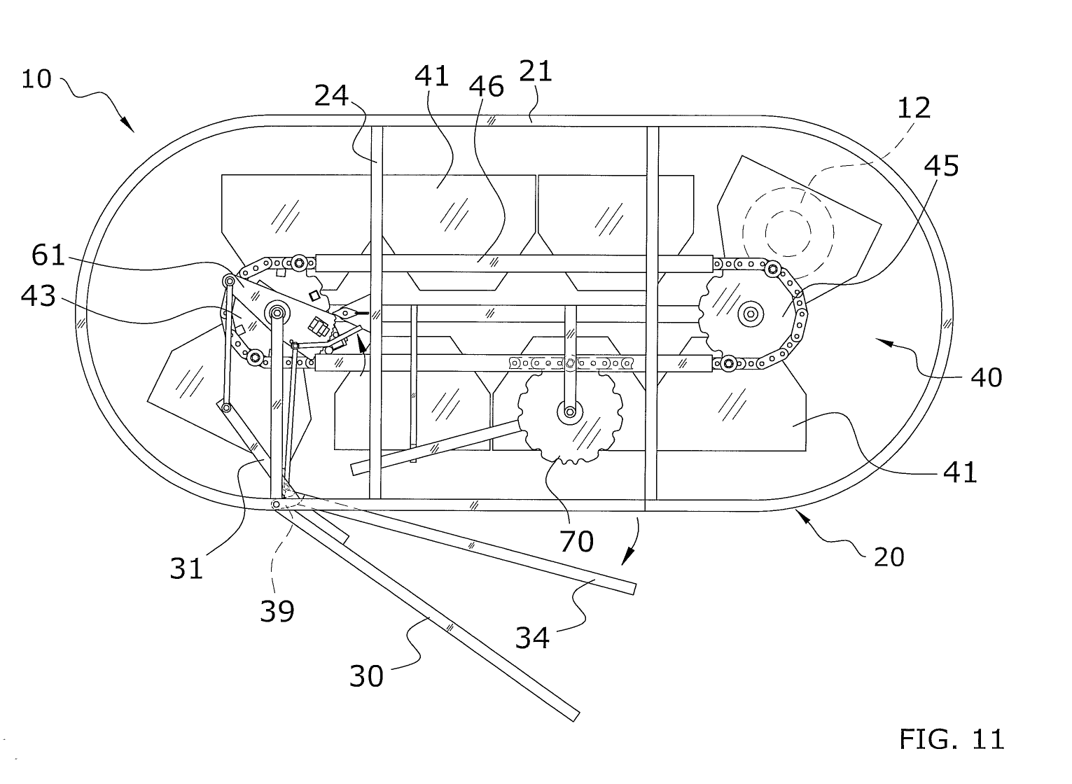

It is appreciated that as long as the panel 34 remains open, a constant force is applied upon the restrictor member 60 to maintain the restrictor member 60 in a pivoted position. The opening of the panel 34 is also illustrated in FIGS. 11 through 13.

The maintenance personnel are now able to exchange the containers 12 in the front of the conveyor assembly 40 (i.e. adjacent the panel 34). To access the other containers 12 within the conveyor assembly 40 the ratcheting sprocket 70 is manipulated via the lever 72 being operated in a ratcheting manner. The ratcheting sprocket 70 thus rotates the chain 42 of the conveyor assembly 40 and thus compartments 41′, 41″, 41′″ and containers 12 into view.

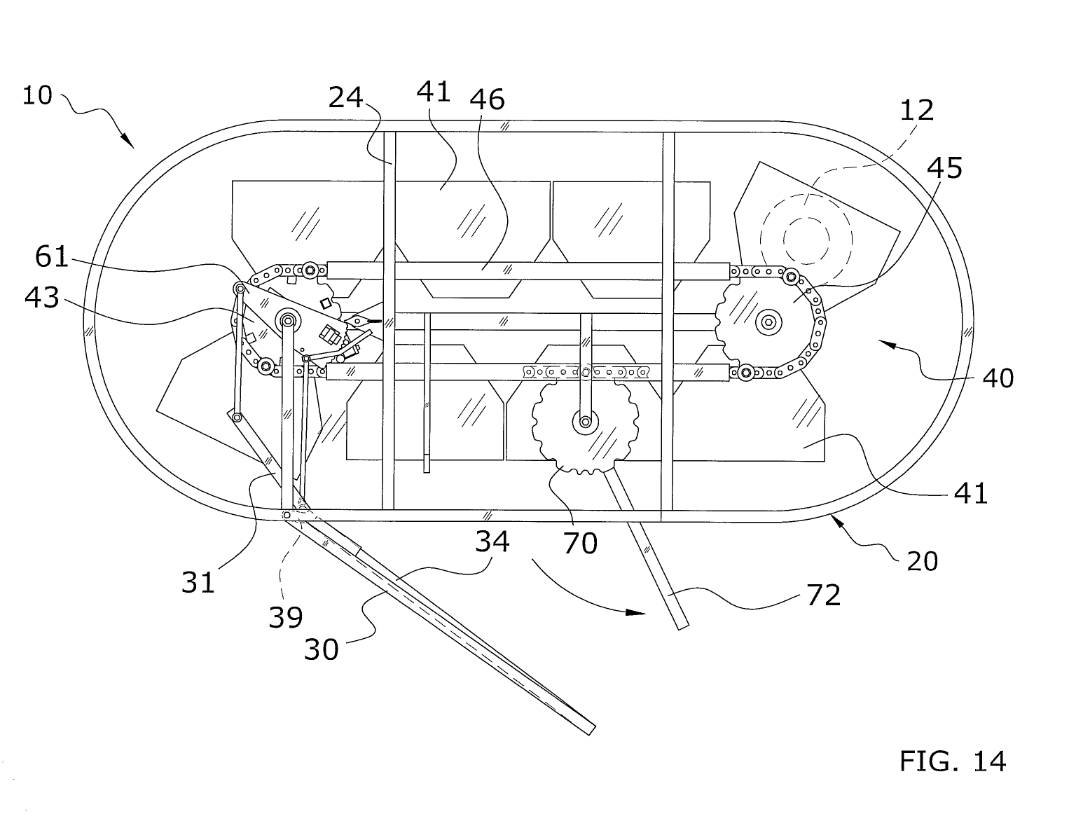

This process is continued until the maintenance personnel have exchanged all the empty containers 12 for full containers 12. The operation of the ratcheting sprocket 70 is also illustrated in FIGS. 14 through 16. The panel 34 and the door 30 may now be closed and locked thus resetting the components of the present invention toward a normal operational manner.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. A vending system, comprising:
an enclosure;
a plurality of openings extending into said enclosure; and
a conveyor assembly including a plurality of compartments, wherein said conveyor assembly is positioned within said enclosure;
wherein said conveyor assembly is capable of supporting a plurality of containers within said plurality of compartments;
wherein only one of said plurality of compartments are aligned with only one of said plurality of openings at one time.

2. The vending system of claim 1, wherein said plurality of openings are staggered.

3. The vending system of claim 2, wherein said plurality of openings are staggered along a vertical axis.

4. The vending system of claim 1, wherein said conveyor assembly includes a plurality of rows.

5. The vending system of claim 4, wherein each of said plurality of rows is in communication with only one of said plurality of openings.

6. The vending system of claim 5, wherein said plurality of openings are staggered along a vertical axis.

7. The vending system of claim 6, wherein said plurality of rows are stacked horizontally.

8. The vending system of claim 1, wherein said plurality of compartments are comprised of a similar size as said plurality of openings.

9. The vending system of claim 1, including a panel, wherein said plurality of openings extend through said panel.

10. The vending system of claim 9, wherein said panel is movably attached to said enclosure.

11. A vending system, comprising:
an enclosure;
a conveyor assembly positioned within said enclosure, wherein said conveyor assembly supports a plurality of containers;
at least one opening extending into said enclosure; and
a door movably attached to said enclosure, wherein said door has a closed position and an open position with respect to said at least one opening;
wherein said door is in communication with said conveyor assembly, whereby when said door moves from said closed position to said open position said conveyor assembly moves only one container of said plurality of containers to a dispensing position with respect to said at least one opening.

12. The vending system of claim 11, wherein said door is mechanically connected to said conveyor assembly.

13. The vending system of claim 11, wherein said conveyor assembly rotates within said enclosure.

14. The vending system of claim 11, wherein said enclosure includes a door opening.

15. The vending system of claim 11, including a drive assembly in communication with said conveyor assembly.

16. The vending system of claim 15, wherein said drive assembly is mechanically connected to said conveyor assembly.

17. The vending system of claim 15, wherein said drive assembly is mechanically connected to said door.

18. The vending system of claim 15, wherein said drive assembly includes a locking structure in communication with said conveyor assembly.

19. The vending system of claim 16, wherein said drive assembly is mechanically connected to said conveyor assembly in a ratcheting manner.

20. A vending system, comprising:
an enclosure including a door opening;
a panel movably attached to said enclosure;
a plurality of openings extending through said panel and into said enclosure,
wherein said plurality of openings are staggered along a vertical axis;
a door movably attached to said enclosure, wherein said door has a closed position and an open position with respect to said at least one opening;
a conveyor assembly including a plurality of compartments, wherein said conveyor assembly is positioned within said enclosure and wherein said conveyor assembly rotates within said enclosure;
wherein said conveyor assembly travels along a chain and sprocket assembly;
wherein said conveyor assembly includes a plurality of rows, wherein each of said plurality of rows is in communication with only one of said plurality of openings;
wherein said plurality of compartments are comprised of a similar size as said plurality of openings;
wherein said plurality of rows are stacked horizontally;
wherein only one of said plurality of compartments are aligned with only one of said plurality of openings at one time;
wherein said door is mechanically connected to said conveyor assembly;
a drive assembly mechanically connected to said conveyor assembly and said door, wherein said drive assembly is mechanically connected to said conveyor assembly in a ratcheting manner;
wherein said drive assembly includes a locking structure in communication with said conveyor assembly; and
a plurality of propane tanks, wherein said plurality of propane tanks are supported within said plurality of compartments of said conveyor assembly;
whereby when said door moves from said closed position to said open position said conveyor assembly moves only one propane tank of said plurality of propane tanks to a dispensing position with respect to said at least one opening.
